(19) United States
(12) Patent Application Publication
(10) Pub. No.: US 2024/0313616 A1
(43) Pub. Date: Sep. 19, 2024

(54) ADJUSTABLE RACKING DEVICE AND METHOD FOR REMOTE RACKING OF SWITCHGEAR

(71) Applicant: CBS ArcSafe, Inc., Denton, TX (US)

(72) Inventors: Lucas Tyler Carfagna, Charleston, WV (US); Russell R. Safreed,, III, Saint Albans, WV (US)

(73) Assignee: CBS ArcSafe, Inc., Denton, TX (US)

(21) Appl. No.: 18/600,491

(22) Filed: Mar. 8, 2024

Related U.S. Application Data
(60) Provisional application No. 63/489,799, filed on Mar. 13, 2023.

(51) Int. Cl. H02K 7/116; H02K 7/00; H02K 7/08; H02K 7/14; H02K 11/20

(52) U.S. Cl. CPC H02K 7/116; H02K 7/003; H02K 7/08; H02K 7/14; H02K 11/20

(57) ABSTRACT

A racking device for remote operation of a circuit breaker or transfer switch comprising: a motor and gear box operatively attached to a racking adapter and an adjustable anti-rotation device affixed to the motor and gear box of the racking device. The adjustable anti-rotation device configured to engage a racking mechanism access window and/or a circuit breaker or transfer switch panel, wherein at least one plane of the anti-rotation device is substantially parallel with at least one plane of the racking mechanism access window and/or the circuit breaker or transfer switch panel and move the anti-rotation device substantially along an x-axis and/or a y-axis of the racking screw access window and/or a circuit breaker panel to compensate for a misalignment or dimensional variances between the racking adapter of the racking device and the racking mechanism of the circuit breaker or transfer switch. Methods of using the racking device are also disclosed.

### CROSS-REFERENCE TO RELATED PATENT APPLICATIONS

This application claims the benefit of and priority to U.S. Provisional Patent Application No. 63/489,799, filed Mar. 13, 2023, which is incorporated herein by reference in its entirety.

### FIELD OF INVENTION

The disclosure is related to the operation of a circuit breaker or transfer switch that have a racking screw or a racking shaft to facilitate removal of the breaker from its cubicle, and in particular, to a portable device that facilitates the remote racking of such circuit breaker or transfer switch.

### BACKGROUND

In larger power systems, a typical draw-out circuit breaker or transfer switch may be connected to or disconnected from an energized bus for maintenance or repair by a human operator who physically rotates a racking screw in order to connect or disconnect the breaker or device from the electrical supply bus.

In order to effect the operation described above, a human operator must stand within arms-reach of the circuit breaker or transfer switch, which also means the operator is in close proximity to the circuit breaker or device. If the circuit breaker or transfer switch should happen to fail catastrophically during the racking operation, the operator is at risk of serious injury or death from the resulting arc-blast and flying debris.

Recognizing the potential hazard of personal injury associated with the local racking operation of an electrical circuit breaker or transfer switch, there is a need for a portable, easy-to-use apparatus that provides a means for remotely racking the circuit breaker or transfer switch from a safe distance.

The apparatus should be easy to use, relatively low weight and cost effective.

### SUMMARY OF THE INVENTION

An object of the disclosure is to provide a portable apparatus that facilitates the remote racking of a circuit breaker or transfer switch by means of utilizing a compact gear motor. Another object of the disclosure is to provide a portable apparatus that is operated from a distance that allows an operator to be positioned a safe distance away from the circuit breaker or transfer switch that is being operated. Yet another object of this disclosure is to provide a portable actuating apparatus that is temporarily affixed to the circuit breaker or transfer switch, in order to facilitate portable use of the invention, without the need of permanently modifying or altering the circuit breaker or transfer switch. Yet another object of this disclosure is to provide a means of remotely racking a circuit breaker or transfer switch without external power except for that mechanical rotational power provided by the commercially available drill motor.

In an aspect of the invention, a racking device for remote operation of a circuit breaker or transfer switch comprises: a motor and gear box operatively attached to a racking adapter configured to be engaged by and secured to a racking mechanism of the circuit breaker or transfer switch; and an adjustable anti-rotation device affixed to the motor and gear box of the racking device, the adjustable anti-rotation device configured to: engage a racking mechanism access window and/or a circuit breaker or transfer switch panel, wherein at least one plane of the anti-rotation device is substantially parallel with at least one plane of the racking mechanism access window and/or the circuit breaker or transfer switch panel; and move the anti-rotation device substantially along an x-axis and/or a y-axis of the racking screw access window and/or a circuit breaker or transfer switch panel to compensate for a misalignment between the racking adapter of the racking device and the racking mechanism of the circuit breaker or transfer switch.

In an embodiment, the adjustable anti-rotation device comprises: a bracket, wherein the bracket is configured to engage one or more of a front surface feature of the circuit breaker or transfer switch panel, a gap in the circuit breaker or transfer switch panel or a side edge of the circuit breaker or transfer switch panel. In an embodiment, the anti-rotation device has one or more “L” bends.

In an embodiment, the bracket comprises: one or more “L” bends configured to engage the one or more of a front surface feature of the circuit breaker or transfer switch panel, a gap in the circuit breaker or transfer switch panel or a side edge of the circuit breaker or transfer switch panel. In an embodiment, the bracket has an “L” bend in the bracket to engage a gap in the circuit breaker or transfer switch panel.

In an embodiment, the adjustable anti-rotation device comprises: a bracket; a first linear bearings moveably attached to the bracket and the racking device and configured to allow an up-down adjustment substantially along the y-axis; a second linear bearings moveably attached to the bracket and the racking device and configured to allow a side to side adjustment substantially along the x-axis.

In an embodiment, the racking adapter is further configured to adjust the racking adapter substantially along a z-axis of the racking mechanism to compensate for a misalignment between the racking adapter of the racking device and the racking mechanism of the circuit breaker or transfer switch.

In an embodiment, the racking adapter comprises: a plurality of holes configured to adjust the racking adapter substantially along a z-axis and to receive a pin, wherein the pin engages one of the plurality of holes in the racking adapter and a hole in the racking mechanism when the racking adapter is in an engaged position.

In an embodiment, the racking adapter comprises: a first hole configured to receive a pin at a first end of the racking adapter, wherein the pin engages the first hole in the racking adapter and a hole in the racking mechanism when the racking adapter is in an engaged position; and/or a sliding cam lock or an expanding two-piece socket at a second end of the racking adapter configured to adjust the racking adapter substantially along the z-axis.

In an embodiment, the racking adapter comprises a socket. In an embodiment, the racking adapter comprises a shaft. In an embodiment, the racking adapter has a hexagonal shape. In an embodiment, the racking adapter has a round or circular shape with the cross-sectional hole. In an embodiment, the racking adapter has a square shape.

In an embodiment, the racking adapter comprises a socket. In an embodiment, the racking adapter comprises a shaft. In an embodiment, the racking adapter has a splined polygonal shape. In an embodiment, the racking adapter has a splined round or circular shape. In an embodiment, the racking adapter has a splined square shape.

In an embodiment, the racking adapter is adapted to be secured to the racking mechanism of the circuit breaker or transfer switch by an engagement means. In an embodiment, the engagement means is one or more of a bracket, a friction fit, a latch, a magnet, and a pin. In an embodiment, the engagement means is a pin.

In another aspect of the invention, a portable racking system for remote operation of a circuit breaker or transfer switch comprises: a racking device comprising a motor and gear box operatively attached to a racking adapter configured to engage a racking mechanism and an anti-rotation device affixed to the motor and gear box of the racking device; a control device comprising a display and a user interface; and a carrying case electrically connected to and communicatively coupled to the racking device and the control device. In an embodiment, the carrying case comprises a power supply and a computer processing device configured to receive, process and relay signals from the racking device to the control device.

In an embodiment, the racking device further comprises: an adjustable position camera device movably attached to the motor and gear box. In an embodiment, the camera device is configured to align a camera aperture to view a circuit breaker or transfer switch panel when the racking adapter of the racking device engages the racking mechanism of the circuit breaker or transfer switch.

In an embodiment, the camera device is adapted to be secured to the motor and gear box of the racking device by an engagement means. In an embodiment, the engagement means is one or more of a friction fit, a knob, and a pin. In an embodiment, the engagement means is a knob.

In an embodiment, the camera device is configured to communicate a video feed to the computer processing device. In an embodiment, the computer processing device is configured to process and relay the video feed to the display of the control device.

In an embodiment, the racking device further comprises: a shaft encoder, the shaft encoder coupled to the motor and gear box of the racking device and configured to determine a distance of and a direction of circuit breaker or transfer switch movement as a function of a number of revolutions of a racking mechanism.

In yet another aspect of the invention, a method to rack-out a circuit breaker or transfer switch comprises: (a) (a-1) inserting an anti-rotation device of a racking device into one or more of a front surface feature, gap or a side edge of a circuit breaker or transfer switch and (a-2) moving the racking adapter of the racking device relative to the racking mechanism of the circuit breaker or transfer switch substantially along an x-axis and/or a y-axis to compensate for misalignment or dimensional variances between the racking adapter of the racking device and the racking mechanism of the circuit breaker or transfer switch; (b) operating the racking adapter of the racking device counterclockwise (or clockwise depending on the circuit breaker or transfer switch) to rack-out the circuit breaker or transfer switch; and (c) stopping operation of the racking adapter of the racking device when the circuit breaker or transfer switch reaches a test position or a remove position.

In an embodiment, step (a-2) further comprises: moving the racking adapter of the racking device relative to the racking mechanism of the circuit breaker or transfer switch substantially along a z-axis to compensate for misalignment between the racking adapter of the racking device and the racking mechanism of the circuit breaker or transfer switch.

In an embodiment, step (a) further comprises: (a-3) securing the racking adapter of the racking device into the racking mechanism of the circuit breaker or transfer switch.

In an embodiment, step (c) further comprises: using an adjustable position camera device to determine when the circuit breaker or transfer switch reaches the test position or the remove position.

In an embodiment, step (c) further comprises: using a revolution counter to determine when the circuit breaker or transfer switch reaches the test position or the remove position.

In an embodiment, step (c) further comprises using an electric current limiter to control the amount of torque and to determine when the circuit breaker or transfer switch reaches the test position or remove position (i.e., to stop the operation when the racking screw reaches end of travel).

In still another aspect of the invention, a method to rack-in a circuit breaker or transfer switch comprises: (a) (a-1) inserting an anti-rotation device of a racking device into a racking mechanism of a circuit breaker or transfer switch and (a-2) moving the racking adapter of the portable racking device relative to the racking mechanism of the circuit breaker or transfer switch substantially along an x-axis and/or a y-axis to compensate for misalignment or dimensional variances between the racking adapter of the racking device and the racking mechanism of the circuit breaker or transfer switch; (b) operating the racking adapter of the racking device clockwise (or counterclockwise depending on the circuit breaker or transfer switch) to rack-in the circuit breaker; and (c) stopping the operation of the racking adapter of the racking device when the circuit breaker or transfer switch reaches a connected position.

In an embodiment, step (a-2) further comprises: moving the racking adapter of the racking device relative to the racking mechanism of the circuit breaker or transfer switch substantially along a z-axis to compensate for misalignment between the racking adapter of the racking device and the racking mechanism of the circuit breaker or transfer switch.

In an embodiment, step (a) further comprises: (a-3) securing the racking adapter of the portable racking device into the racking mechanism of the circuit breaker or transfer switch.

In an embodiment, step (c) further comprises using a camera device to determine when the circuit breaker or transfer switch reaches the connected position. In an embodiment, the method further comprises (d) removing the racking adapter of the racking device from the racking mechanism of the circuit breaker or transfer switch.

In an embodiment, step (c) further comprises using a revolution counter to determine when the circuit breaker or transfer switch reaches the connected position. In an embodiment, the method further comprises (d) removing the racking adapter of the racking device from the racking mechanism of the circuit breaker or transfer switch.

In an embodiment, step (c) further comprises using an electric current limiter to control the amount of torque and to determine when the circuit breaker or transfer switch reaches the test position or remove position (i.e., to stop the operation when the racking screw reaches end of travel). In an embodiment, the method further comprises (d) removing the racking adapter of the racking device from the racking mechanism of the circuit breaker or transfer switch.

These and other objects, features and advantages will become apparent as reference is made to the following detailed description, preferred embodiments, and examples, given for the purpose of disclosure, and taken in conjunction with the accompanying drawings and appended claims.

### BRIEF DESCRIPTION OF THE DRAWINGS

For a further understanding of the nature and objects of the present invention, reference should be made to the following detailed disclosure, taken in conjunction with the accompanying drawings, in which like parts are given like reference numerals, and wherein:

FIG. 1 illustrates a front, right perspective view of a circuit breaker or transfer switch panel of a circuit breaker, showing a front surface of the circuit breaker or transfer switch panel, a gap between circuit breaker or transfer switch panels, a side edge of the circuit breaker or transfer switch panel and a racking mechanism;

FIG. 1A illustrates a simplified embodiment of a circuit breaker showing a front face.

FIG. 2 illustrates a detailed view of a circuit breaker or transfer switch panel of a circuit breaker, showing a racking mechanism window, a racking mechanism access window shutter, a racking mechanism, a breaker position indicator and a breaker position indicator label;

FIG. 3A illustrates a front, right side perspective view of a racking device, showing a racking adaptor in a dis-engaged position, an anti-rotation device, a first linear bearings, a motor and gear box, a pin and an adjustable position camera device;

FIG. 3B illustrates an upper rear, left perspective view of the racking device of FIG. 3A, showing the racking adaptor in the dis-engaged position, the first linear bearings, a second linear bearings, an up-down adjustment (y-axis) and a side to side adjustment (x-axis);

FIG. 4 illustrates a front, right perspective view of a circuit breaker or transfer switch panel for a circuit breaker or transfer switch, showing an exemplary racking adaptor of a racking device in an engaged position and ready to operate the racking mechanism;

FIG. 5 illustrates a schematic of a portable racking system, showing a racking device, an optional adjustable position camera device having a camera aperture, and a carrying case having a power supply, and a control device;

FIG. 6A illustrates a rear view of an anti-rotation device positioned for a circuit breaker or transfer switch having a racking mechanism located to the right of and high of center in relation to a lower edge of a circuit breaker or transfer switch panel;

FIG. 6B illustrates a rear view of an anti-rotation device positioned for a circuit breaker or transfer switch having a racking mechanism located to the right of and high of center in relation to a lower edge of a circuit breaker or transfer switch panel;

FIG. 6C illustrates a rear view of an anti-rotation device positioned for a circuit breaker or transfer switch having a racking mechanism located to the left of and low of center in relation to a lower edge of a circuit breaker or transfer switch panel;

FIG. 6D illustrates a rear view of an anti-rotation device positioned for a circuit breaker or transfer switch having a racking mechanism located to the left of and high of center in relation to a lower edge of a circuit breaker or transfer switch panel;

FIG. 7 illustrates an upper, left side perspective view of a racking device having a plurality of holes, showing the racking adaptor in an engaged position, showing a pin engaged in one of the plurality of holes, and an in-out adjustment (z-axis);

FIG. 8 illustrates rear, right side perspective view an alternative racking adapter having a first portion and a second portion, showing a pin and an in-out adjustment (z-axis);

FIG. 9A illustrates a rear, right side perspective view of an adjustable position camera device, showing a camera housing and a knob;

FIG. 9B illustrates a lower, left side perspective view of the adjustable position camera device of FIG. 9A, showing a camera aperture; and

FIG. 10 illustrates an exemplary racking adapter, showing a splined racking adapter having a splined round or circular shape.

### DETAILED DESCRIPTION

The following detailed description of various embodiments of the present invention references the accompanying drawings, which illustrate specific embodiments in which the invention can be practiced. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains. Therefore, the scope of the present invention is defined only by the appended claims, along with the full scope of equivalents to which such claims are entitled.

In the following detailed description and the attached drawings, specific details are set forth to provide a thorough understanding of the present disclosure. However, those skilled in the art will appreciate that the present disclosure may be practiced, in some instances, without such specific details. In other instances, well-known elements have been illustrated in schematic or block diagram form in order not to obscure the present disclosure in unnecessary detail. Additionally, for the most part, specific details, and the like, have been omitted inasmuch as such details are not considered necessary to obtain a complete understanding of the present disclosure, and are considered to be within the understanding of persons of ordinary skill in the relevant art.

### Racking Device for Remote Racking of Switchgear

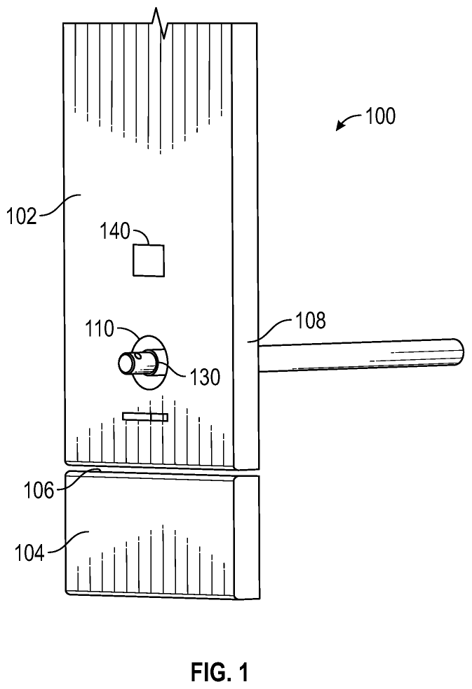

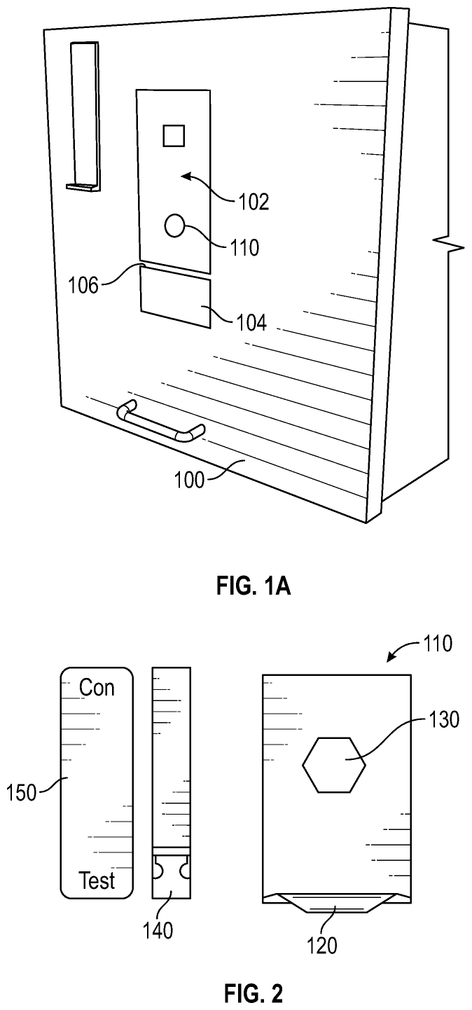

FIG. 1 illustrates a front, right perspective view of a circuit breaker or transfer switch panel 102 of a circuit breaker or transfer switch 100 (FIG. 1A), showing a front surface 104 of the circuit breaker or transfer switch panel 102, a gap 106 between circuit breaker or transfer switch panel 102, a side edge 108 of the circuit breaker or transfer switch panel 102 and a racking mechanism 130.

According to embodiments disclosed herein, the circuit breaker or transfer switch 100 may be any suitable circuit breaker or transfer switch. For example, a suitable circuit breaker or transfer switch includes, but is not limited to, a draw-out circuit breaker or transfer switch, and any equivalent thereof.

In an embodiment, the racking mechanism 130 may be any suitable mechanism to rack-in or rack-out the circuit breaker or transfer switch. For example, a suitable racking mechanism 130 includes, but is not limited to, a racking screw, a racking socket, or any variation thereof. In an embodiment, the racking mechanism 130 may be a racking screw. In an embodiment, the racking mechanism 130 may be a racking socket (not shown).

In an embodiment, the racking mechanism 130 may comprise one or more flats. In an embodiment, the racking mechanism 130 may comprise one or more flats on the racking screw. In an embodiment, the racking mechanism 130 may comprise one or more flats on the racking socket (not shown).

According to embodiments disclosed herein, the racking mechanism 130 may comprise one or more holes to receive a pin 210. In an embodiment, the racking mechanism 130 may comprise one or more holes in the racking screw to receive a pin 210. In an embodiment, the racking mechanism 130 may comprise one or more holes on the racking socket (not shown) to receive a pin 210.

### Circuit Breaker or Transfer Switch Panel

FIG. 1 illustrates a front, right perspective view of a circuit breaker or transfer switch front panel 102 of a circuit breaker or transfer switch 100 (located behind the panel), showing a front surface 104 of the circuit breaker or transfer switch front panel 102, a gap 106 between circuit breaker or transfer switch panel 102, a side edge 108 of the circuit breaker or transfer switch panel 102 and a racking mechanism 130. FIG. 2 illustrates a detailed view of a circuit breaker or transfer switch panel 102 of a circuit breaker or transfer switch 100, showing a racking mechanism window 110, a racking mechanism access window shutter, a racking mechanism 130, a breaker position indicator 140 and a breaker.

As shown in FIGS. 1 and 2, the circuit breaker or transfer switch 100 comprises a circuit breaker or transfer switch panel 102 having a front surface 104, a gap 106, a side edge 108, a racking access window 110, a racking mechanism access window shutter 120, and a racking mechanism 130.

### Circuit Breaker Position Indicator

FIG. 2 illustrates a detailed view of a circuit breaker or transfer switch panel 102 of a circuit breaker or transfer switch 100, showing a racking mechanism window 110, a racking mechanism access window shutter 120, a racking mechanism 130, a breaker position indicator 140 and a breaker position indicator label 150.

As shown in FIG. 2, the circuit breaker or transfer switch 100 comprises a circuit breaker position indicator 140 having a circuit breaker position indicator label 150, showing a “con” (connect) position and a “test” (remove) position.

### Racking Device

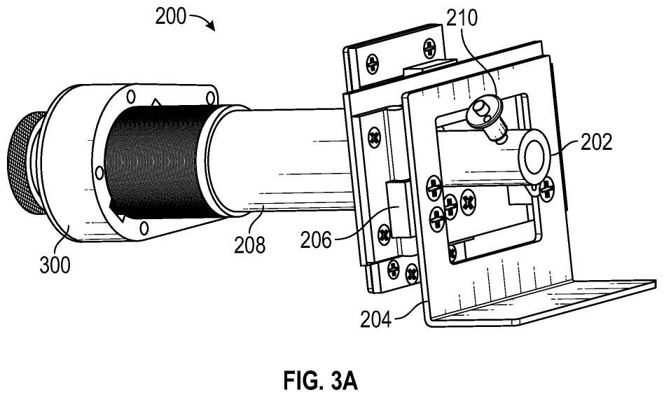

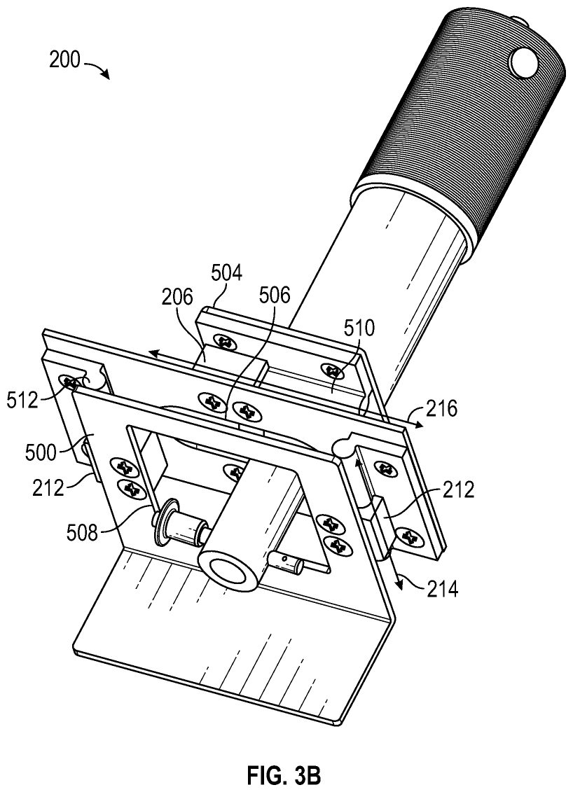

FIG. 3A illustrates a front, right side perspective view of a racking device 200, showing a racking adaptor 202 in a dis-engaged position, an anti-rotation device 204, a first linear bearings 206, a motor and gear box 208, a pin 201, and an adjustable position camera device 300. FIG. 3B illustrates an upper rear, left perspective view of the racking device 200 of FIG. 3A, showing the racking adaptor 202 in the dis-engaged position, the first linear bearings 206, a second linear bearings 212, an up-down adjustment (y-axis) 214 and a side to side adjustment (x-axis) 216.

FIG. 4 illustrates a front, right perspective view of a circuit breaker or transfer switch panel 102 for a circuit breaker or transfer switch 100, showing a racking adaptor 202 of a racking device 200 in an engaged position and ready to operate the racking mechanism 130 of the circuit breaker or transfer switch 100.

As shown in FIGS. 3A and 3B, a racking device 200 comprises a racking adapter 202, an adjustable anti-rotation device 204, a motor and gearbox 208, a pin 210, and an optional adjustable position camera device. In an embodiment, the anti-rotation device 204 comprises a first linear bearings 206, a second linear bearings 212, an up-down adjustment 214 (i.e., y-axis), a side-to-side adjustment 216 (i.e., x-axis).

In use, and as explained in greater detail below, the racking device 200 is operable to be adjusted along an x-axis, a y-axis and a z-axis so as to enable the racking device 2. According to embodiments disclosed herein, the racking device 200 may be portable or stationary.

### Portable Racking System

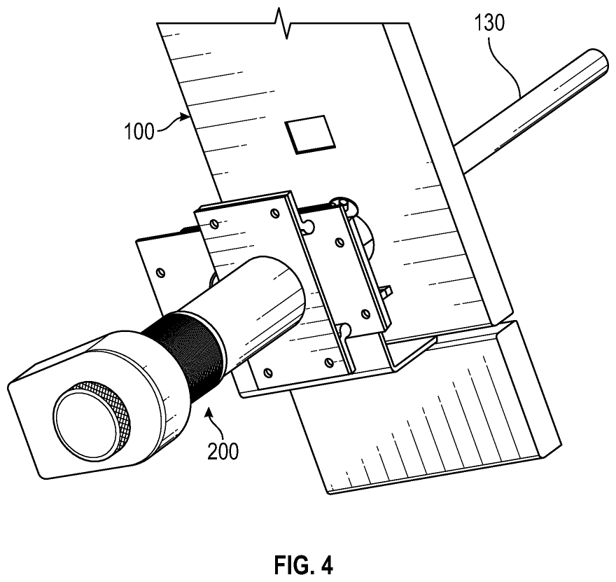

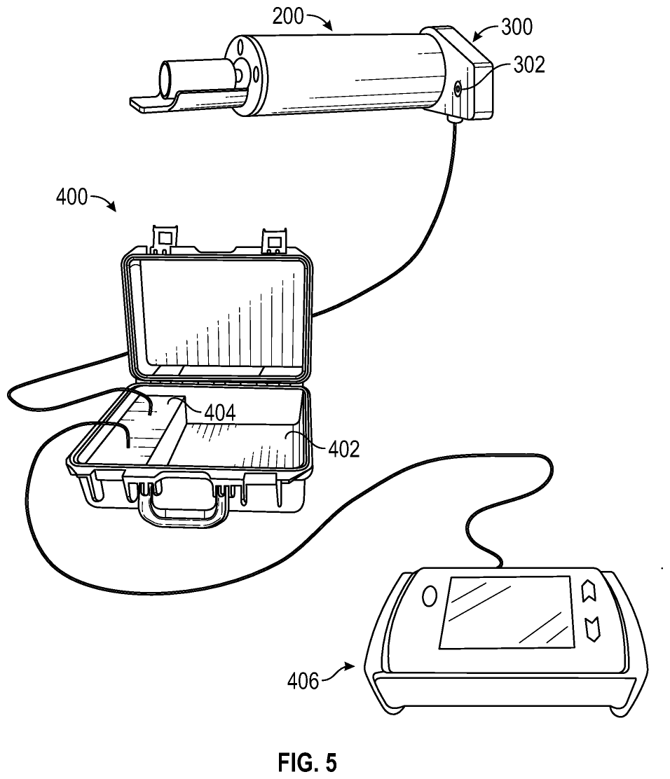

FIG. 5 illustrates a schematic of a portable racking system 400, showing a racking device 200, an optional adjustable position camera device 300 having a camera aperture 302, and a carrying case 402 having a computer processing device and a power supply 404, and a control device 406.

As shown in FIG. 5, the portable racking system 400 comprises: a racking device 200 comprising a motor and gear box 208 operatively attached to a racking adapter 202 configured to engage a racking mechanism 130 of the circuit breaker or transfer switch 100. FIG. 5 further illustrates a control device 406 comprising a display and a user interface; and a carrying case 402 electrically connected to and communicatively coupled to the racking device 200 and the control device 406. In an embodiment, the carrying case 402 comprises a power supply and a computer processing device 404 configured to receive, process and relay signals from the racking device 200 to the control device 406.

In the embodiment illustrated in FIG. 5, the carrying case 402 is electrically connected to and communicatively connected to the camera device 300, which can be optional. In operation, the camera device 300 is configured to communicate a video feed to the computer processing device, and the computer processing device is configured to process and relay the video feed to the display of the control device.

### Racking Adapter

In an embodiment, the racking device 200 has a first end 201 and a second end 203. The first end 201 of the racking device 200 has the racking adapter 202 and the second end 203 of the racking device 200 includes the optional adjustable position camera device 300, as discussed below.

In an embodiment, the racking adapter 202 comprises a socket. In a further embodiment, the racking adapter 202 may comprise one or more flats on the socket. In yet another embodiment, the racking adapter 202 comprises a shaft (not shown). In an embodiment, the racking adapter 202 may comprise one or more flats on the shaft (not shown).

According to some embodiments, the racking adapter 202 and the socket may be geometrically designed to engage the racking mechanism 130 of the circuit breaker or transfer switch 100. For example, the racking adapter 202 in combination with the socket may be designed to engage the racking mechanism 130 of the circuit breaker or transfer switch 100 and to provide a mechanical method to counteract the anti-torque that is experienced by the racking adapter 202 as the circuit breaker or transfer switch 100 is racked.

In use, the racking adapter 202 may be installed by aligning the racking adapter 202 and socket to the racking mechanism 130 of the circuit breaker or transfer switch 100. The racking adapter 202 is then fully inserted so that the socket is fully engaged to the racking mechanism 130 of the circuit breaker or transfer switch 100.

According to embodiments disclosed herein, the racking adapter 202 may be held and engaged to the racking mechanism 130 of the circuit breaker or transfer switch 100 by any suitable engagement means. For example, a suitable engagement means includes, but is not limited to, a bracket, a friction fit (e.g., between physical shape and/or openings of the racking adapter 202 and physical shape and/or openings of racking mechanism 130), a latch, a magnet, a pin 210, and combinations thereof. In an embodiment, the racking adapter 202 may be held engaged to the racking mechanism 130 of the circuit breaker or transfer switch 100 by a pin 210.

### Anti-Rotation Device

As shown in FIGS. 3A and 3B, the anti-rotation device 204 comprises a first linear bearings 206, a second linear bearings 212, an up-down adjustment 214 (i.e., y-axis), a side-to-side adjustment 216 (i.e., x-axis).

In an embodiment, the first linear bearings 206 allow the anti-rotation device 204 to be moved for a side to side adjustment 216 (i.e., x-axis).

In an embodiment, the second linear bearings 212 allow the anti-rotation device 204 to be moved for an up-down adjustment 214 (i.e., y-axis).

In an embodiment, the anti-rotation device comprises a bracket. In an embodiment, the anti-rotation device 204 may comprise one or more “L” bends in the bracket. In an embodiment, the anti-rotation device 204 comprises a flat tang.

According to embodiments disclosed herein, the anti-rotation device 204 may be geometrically designed to engage a circuit breaker or transfer switch panel 102 of the circuit breaker or transfer switch 100. In an embodiment, the anti-rotation device 204 may be designed to engage the circuit breaker or transfer switch panel 102 of the circuit breaker or transfer switch 100 and to provide a mechanical method to counteract the anti-torque that is experienced by the racking adapter 202 as the circuit breaker or transfer switch 100 is racked.

In use, the anti-rotation device 204 may be installed by aligning the anti-rotation device 204 with, for example, a front surface 104 feature, a gap 106 or a side edge 108 of the circuit breaker or transfer switch panel 102 of the circuit breaker or transfer switch 100. The anti-rotation device 204 is then fully inserted in the front surface 104 feature, the gap 106 or along the side edge 108 so that the anti-rotation device 204 is fully engaged to the circuit breaker or transfer switch panel 102 of the circuit breaker or transfer switch 100.

In an embodiment, the anti-rotational device 204 may be held engaged to the circuit breaker or transfer switch panel 102 of the circuit breaker or transfer switch 100 by any suitable engagement means. For example, a suitable engagement means includes, but not limited to, a bracket, a friction fit (e.g., between physical shape and/or openings of the anti-rotational device 204 and physical shape and/or openings of circuit breaker or transfer switch panel), a latch, a magnet, a pin, and combinations thereof. In an embodiment, the anti-rotational device 204 may be held engaged to the circuit breaker or transfer switch panel 102 of the circuit breaker or transfer switch 100 by a friction fit.

Adjustment Along X-Axis and/or Y-Axis

It should be understood that the anti-rotational device 204 may be movable relative to the circuit breaker or transfer switch panel of the circuit breaker or transfer switch 100 by any suitable sliding means. For example, a suitable sliding means includes, but not limited to, a linear bearing, a track and pin, and combinations thereof. In an embodiment, the anti-rotational device 204 may be movable relative to the circuit breaker or transfer switch panel 102 of the circuit breaker or transfer switch 100 by a linear bearing. In an embodiment, the anti-rotational device 204 may be movable relative to the circuit breaker or transfer switch panel 102 of the circuit breaker or transfer switch 100 by a track and pin.

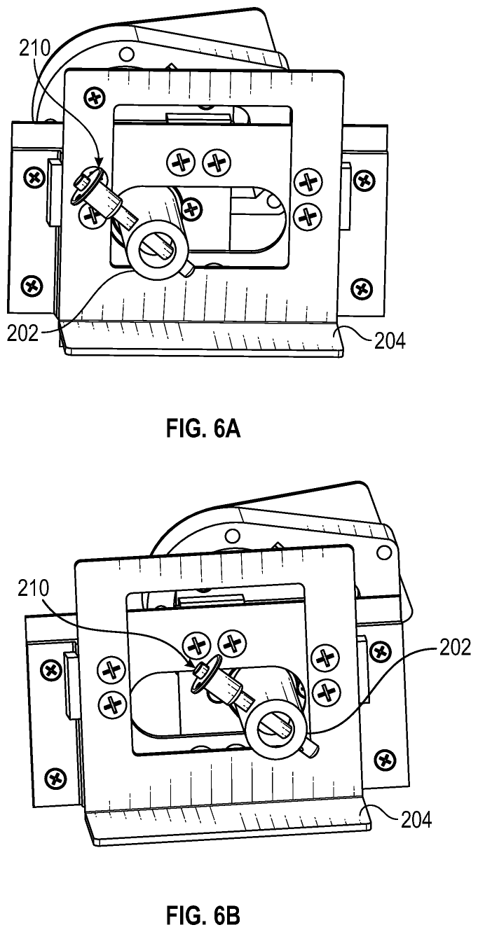

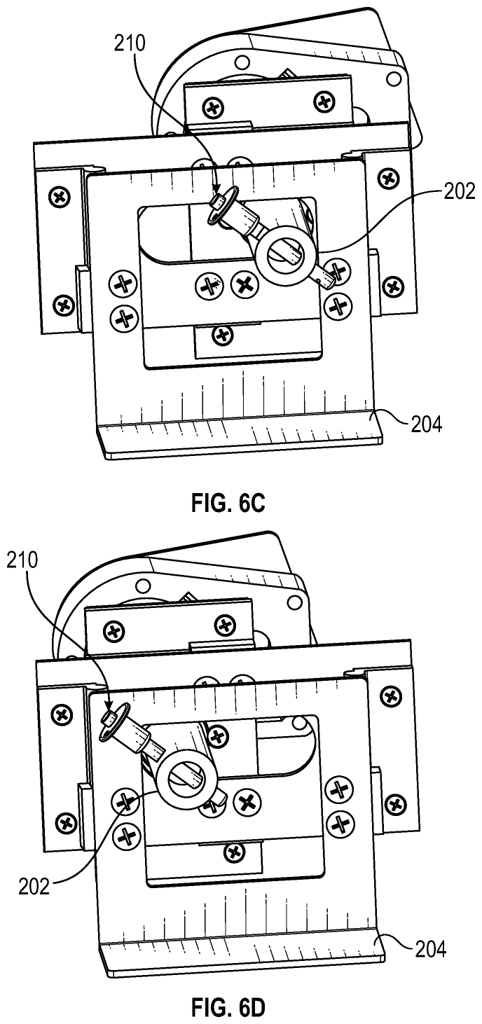

FIG. 6A illustrates a rear view of an anti-rotation device 204 positioned for a circuit breaker or transfer switch 100 having a racking mechanism 130 located to the right of and high of center in relation to a lower edge of a circuit breaker or transfer switch panel 102; FIG. 6B illustrates a rear view of an anti-rotation device 204 positioned for a circuit breaker or transfer switch 100 having a racking mechanism 130 located to the right of and high of center in relation to a lower edge of a circuit breaker or transfer switch panel 102; FIG. 6C illustrates a rear view of an anti-rotation device 204 positioned for a circuit breaker or transfer switch 100 having a racking mechanism 130 located to the left of and low of center in relation to a lower edge of a circuit breaker or transfer switch panel 102; and FIG. 6D illustrates a rear view of an anti-rotation device 204 positioned for a circuit breaker or transfer switch 100 having a racking mechanism 130 located to the left of and high of center in relation to a lower edge of a circuit breaker or transfer switch panel 102.

As shown in FIGS. 3A-3B and 6A-6D, the anti-rotation device 204 may be geometrically designed to adjust to and engage a circuit breaker or transfer switch panel 102 of a circuit breaker or transfer switch 100. In an embodiment, the anti-rotation device 204 may be designed to adjust to and engage the circuit breaker or transfer switch panel 102 of the circuit breaker or transfer switch 100 and to provide a mechanical method to counteract misalignments between the racking adapter 202 of the racking device 200 and the racking mechanism 130 of the circuit breaker or transfer switch 100.

In an embodiment, the first linear bearings 206 allow the anti-rotation device 204 to be moved for a side to side adjustment 216 (i.e., x-axis).

In an embodiment, the second linear bearings 212 allow the anti-rotation device 204 to be moved for an up-down adjustment 214 (i.e., y-axis).

Referring now specifically to FIGS. 3A-3B and FIGS. 6A-6B, the anti-rotation device 204 is formed having a base member 500, a first or vertical movable member 502 movable in the direction of arrow 214 (i.e., along the y-axis) and a second or horizontal movable member 504 that is movable in the direction of arrow 216 (i.e., along the x-axis). As illustrated, the base member 502 and the vertical movable member 502 are formed having respective opening 506 and 508 sized and positioned to receive at least a portion of the racking mechanism racking adapter 202 therethrough and to, as discussed in greater detail, to enable alignment of the racking adapter 202 relative to the racking mechanism 130.

Relative movement of the members 500, 502 and 504 is facilitated by one or more vertical tracks 510 (disposed on member 502) and one or more horizontal tracks 512 (disposed on member 504). Referring specifically to FIG. 3B, for example, the vertical movable member 502 is formed having a pair of parallel vertical tracks 510 to enable the second linear bearings 212 to move along the tracks 510 to position the anti-rotation device 204, and thus, the racking adapter 504 vertically relative to the racking mechanism 130. As illustrated in FIG. 3B, the horizontal tracks 512 (only 1 track 512 illustrated) are disposed on the base member 504 to enable the first linear bearing 206 to move therealong to horizontally position the base member 504, and thus, the racking adapter 504 to which it is secured, relative to the racking mechanism 130. It should be understood that other configurations for positioning the racking adapter 504 may be incorporated.

### Adjustable Racking Adaptor

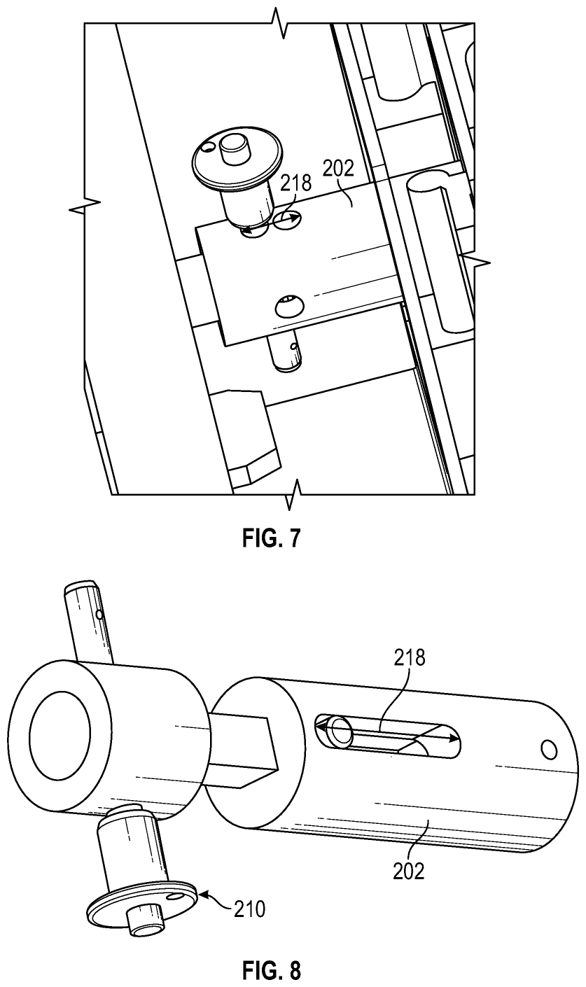

FIG. 7 illustrates an upper, left side perspective view of a racking device 200, showing an adjustable racking adaptor 202 having a plurality of holes, a pin 210 engaged in one of the plurality of holes, and an in-out adjustment (i.e., along a z-axis) 218.

In an embodiment, the racking adapter 202 may be movable relative to the circuit breaker or transfer switch panel 102 of the circuit breaker or transfer switch 100 by any suitable sliding means. For example, a suitable sliding means includes, but not limited to, one or more holes configured to receive a pin, and combinations thereof. In an embodiment, the racking adapter 202 may be movable relative to the circuit breaker or transfer switch panel 102 of the circuit breaker or transfer switch 100 by one or more holes configured to receive a pin.

In an embodiment, the racking adapter 202 comprises a plurality of holes configured to adjust the racking adapter 202 substantially along a z-axis and to receive a pin 210. In an embodiment, the racking mechanism 130 comprises a hole to receive the pin 210 when the racking adapter 202 is in an engaged position.

FIG. 8 illustrates rear, right side perspective view an alternative racking adapter 202 having a first portion and a second portion, showing a pin 210 and an in-out adjustment (z-axis) 218.

In an embodiment, the racking adapter 202 may be movable relative to the circuit breaker or transfer switch panel 102 of the circuit breaker or transfer switch 100 by any suitable sliding means. For example, a suitable sliding means includes, but not limited to, an expanding two-piece socket, a sliding cam lock, and combinations thereof. In an embodiment, the racking adapter 202 may be movable relative to the circuit breaker or transfer switch panel 102 of the circuit breaker or transfer switch 100 by an expandable two-piece socket. In an embodiment, the racking adapter 202 may be movable relative to the circuit breaker or transfer switch panel 102 of the circuit breaker or transfer switch 100 by a sliding cam lock.

In an embodiment, the first portion of the racking adapter 202 comprises one or more holes at a first end of the racking adapter 202 configured to adjust the racking adapter 200 substantially along a z-axis and to receive a pin 210. In an embodiment, the racking mechanism 130 comprises a hole to receive the pin 210 when the racking adapter 202 is in an engaged position.

In an embodiment, the second portion of the racking adapter 202 comprises a sliding cam lock at the second end of the racking adapter 202 configured to adjust the racking adapter substantially along a z-axis.

In an embodiment, the second portion of the racking adapter 202 comprises an expanding two-piece socket at the second end of the racking adapter 202 configured to adjust the racking adapter substantially along a z-axis.

In an embodiment, the racking adapter 202 comprises one or more holes at a first end of the racking adapter 202 configured to adjust the racking adapter 202 substantially along a z-axis and to receive a pin 210. In an embodiment, the racking mechanism 130 comprises a hole to receive the pin 210 when the racking adapter 202 is in an engaged position. In an embodiment, the racking adapter 202 comprises a sliding cam lock or an expanding two-piece socket at the second end of the racking adapter 202 configured to adjust the racking adapter substantially along a z-axis.

### Motor and Gearbox

In an embodiment, the motor and gearbox 208 has an input and an output. In an embodiment, the motor and gearbox 208 may be incorporated between a nonconductive section and the racking adapter 202 to provide a torque multiplication required to rack the circuit breaker or transfer switch 100.

In an embodiment, the nonconductive section creates a break in conductivity such that the operator may be insulated from an arc flash or an electrical discharge by the nonconductive linkage or section.

In an embodiment, the nonconductive section may be made of any suitable nonconductive material. For example, a suitable nonconductive material includes, but is not limited to, a nonmetallic material, and combinations thereof. In an embodiment, the nonconductive linkage or the nonconductive section may be made from a plastic or a polymer resin.

In an embodiment, the nonconductive section has a first end and a second end. In an embodiment, a racking adapter 202 may be connected to the first end of the nonconductive section. In an embodiment, the motor and gearbox 208 is incorporated between the nonconductive section and the racking adapter 202 to provide a torque multiplication required to rack the circuit breaker or transfer switch 100.

### Optional Revolution Counter

In an embodiment, the racking device 200 may comprise an optional revolution counter (not shown) capable of counting the revolutions. In an embodiment, the operator may be able to know the number of revolutions required to rack-out the circuit breaker or transfer switch 100, and, therefore, the operator may be able to know the number of revolutions should be required to rack-in the circuit breaker or transfer switch 100.

### Optional Current Limiter

In an embodiment, the racking device 200 may comprise an optional current limiter (not shown) control the amount of torque and to determine when the circuit breaker or transfer switch reaches the test position or remove position (i.e., to stop the operation when the racking screw reaches end of travel) or to determine when the circuit breaker or transfer switch reaches the connected position.

### Optional Adjustable Position Camera Device

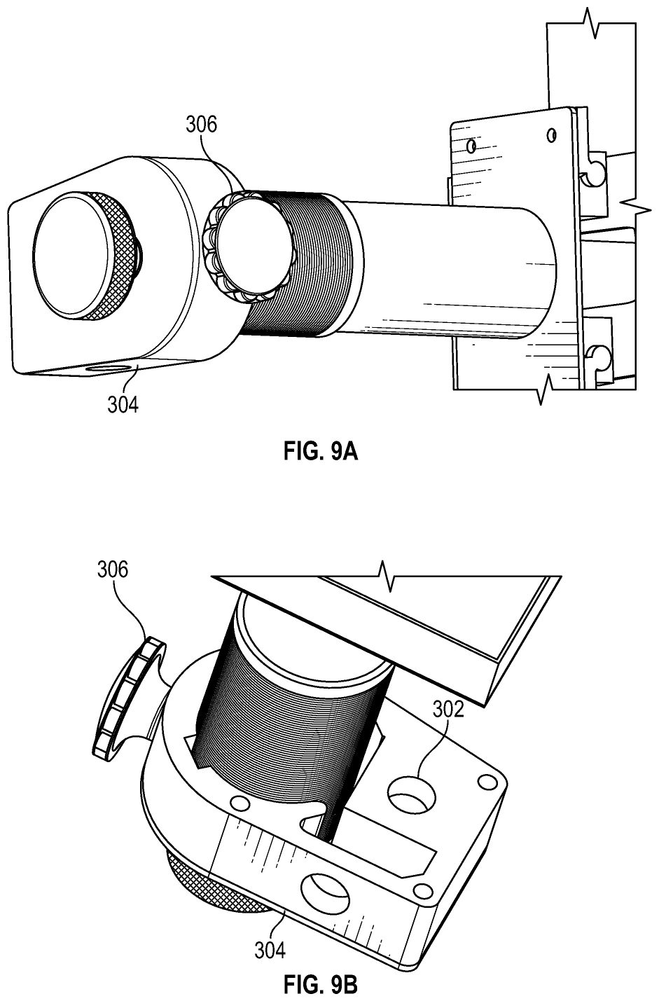

FIG. 9A illustrates a rear, right side perspective view of an adjustable position camera device 300, showing a camera housing 304 and a knob 306; FIG. 9B illustrates a lower, left side perspective view of the adjustable position camera device 300 of FIG. 9A, showing a camera aperture 302.

As shown in FIGS. 9A and 9B, the racking device 200 may comprises an optional adjustable position camera device 300 having a camera aperture 302, a camera housing 304 and a knob 306.

In an embodiment, the camera device 300 may be held engaged to the motor and gear box 208 of the racking device 200 by any suitable engagement means. For example, a suitable engagement means includes, but not limited to, a bracket, a friction fit (e.g., between physical shape and/or openings of the camera device and physical shape and/or openings of motor and gear box 208), a latch, a knob 306, and combinations thereof. In an embodiment, the camera device 300 may be held engaged to the motor and gear box 208 of the racking device 200 by a knob 306.

In an embodiment, the camera device 300 is configured to align a camera aperture 302 to view a circuit breaker or transfer switch panel 102 of a circuit breaker or transfer switch 100 or a circuit breaker position indicator 140 of the circuit breaker 100 when the racking adapter 202 of the racking device 200 engages the racking mechanism 130 of the circuit breaker or transfer switch 100.

As shown in FIG. 2, the circuit breaker or transfer switch 100 comprises a circuit breaker position indicator 140 having a circuit breaker position indicator label 150, showing a “con” (connect) position and a “test” (remove) position.

In an embodiment, the camera device 300 is configured to communicate a camera feed to the computer processing device (not shown), and the computer processing device (not shown) is configured to relay the video feed to the display of the control device 406.

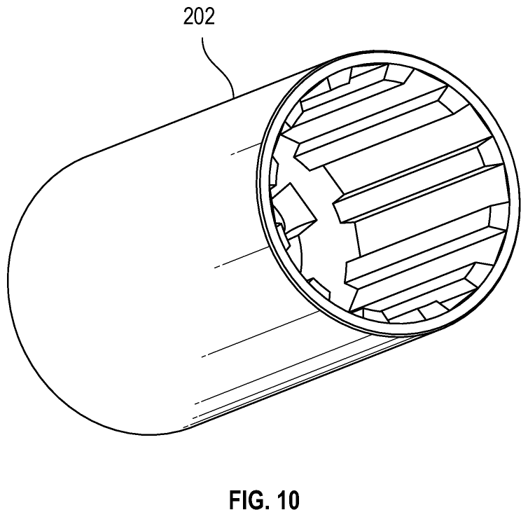

Reference is now made to FIG. 10, which depicts a front side perspective view of an alternative embodiment of a racking adapter 202, having a splined round or circular shape. The splines of the splined racking adapter 202 are sized and positioned to mate with corresponding splines or channels on a racking mechanism 130. It should be understood that while the splines of the splined racking adapter 202 are presently depicted as inwardly extending ridges, alternate configurations are also envisioned. For example, the splines may be flat sides formed on the interior surface of the racking adapter 202 (e.g., a socket).

### Method of Using Apparatus for Remote Racking of Switchgear

### Method to Rack-Out Circuit Breaker or Transfer Switch

In an embodiment, a method to rack-out a circuit breaker or transfer switch comprises: (a) (a-1) inserting an anti-rotation device of a racking device into one or more of a front surface feature, gap or a side edge of a circuit breaker or transfer switch and (a-2) moving the racking adapter 202 of the racking device 200 relative to the racking mechanism 130 of the circuit breaker substantially along an x-axis and/or a y-axis to compensate for misalignment or dimensional variances between the racking adapter of the racking device and the racking mechanism of the circuit breaker or transfer switch; (b) operating the racking adapter of the racking device counterclockwise (or clockwise depending on the circuit breaker or transfer switch) to rack-out the circuit breaker or transfer switch; and (c) stopping operation of the racking adapter of the racking device when the circuit breaker or transfer switch reaches a test position or a remove position.

In an embodiment, step (a-2) further comprises: moving the racking adapter of the racking device relative to the racking mechanism of the circuit breaker or transfer switch substantially along a z-axis to compensate for misalignment between the racking adapter of the racking device and the racking mechanism of the circuit breaker or transfer switch.

In an embodiment, step (a) further comprises: (a-3) securing the racking adapter of the racking device into the racking mechanism of the circuit breaker or transfer switch.

In an embodiment, step (c) further comprises: using an adjustable position camera device to determine when the circuit breaker or transfer switch reaches the test position or the remove position.

In an embodiment, step (c) further comprises: using a revolution counter to determine when the circuit breaker or transfer switch reaches the test position or the remove position.

In an embodiment, step (c) further comprises using an electric current limiter to control the amount of torque and to determine when the circuit breaker or transfer switch reaches the test position or remove position (i.e., to stop the operation when the racking screw reaches end of travel).

### Method to Rack-In Circuit Breaker or Transfer Switch

In an embodiment, a method to rack-in a circuit breaker or transfer switch comprises: (a)(a-1) inserting an anti-rotation device of a racking device into a racking mechanism of a circuit breaker or transfer switch and (a-2) moving the racking adapter of the portable racking device relative to the racking mechanism of the circuit breaker or transfer switch substantially along an x-axis and/or a y-axis to compensate for misalignment or dimensional variances between the racking adapter of the racking device and the racking mechanism of the circuit breaker or transfer switch; (b) operating the racking adapter of the racking device clockwise (or counterclockwise depending on the circuit breaker or transfer switch) to rack-in the circuit breaker or transfer switch; and (c) stopping the operation of the racking adapter of the racking device when the circuit breaker or transfer switch reaches a connected position.

In an embodiment, step (a-2) further comprises: moving the racking adapter of the racking device relative to the racking mechanism of the circuit breaker or transfer switch substantially along a z-axis to compensate for misalignment between the racking adapter of the racking device and the racking mechanism of the circuit breaker or transfer switch.

In an embodiment, step (a) further comprises: (a-3) securing the racking adapter of the portable racking device into the racking mechanism of the circuit breaker or transfer switch.

In an embodiment, step (c) further comprises: using a camera device to determine when the circuit breaker or transfer switch reaches the connected position. In an embodiment, the method further comprises: (d) removing the racking adapter of the racking device from the racking mechanism of the circuit breaker or transfer switch.

In an embodiment, step (c) further comprises: using a revolution counter to determine when the circuit breaker or transfer switch reaches the connected position. In an embodiment, the method further comprises: (d) removing the racking adapter of the racking device from the racking mechanism of the circuit breaker or transfer switch.

In an embodiment, step (c) further comprises using an electric current limiter to control the amount of torque and to determine when the circuit breaker or transfer switch reaches the connected position. In an embodiment, the method further comprises: (d) removing the racking adapter of the racking device from the racking mechanism of the circuit breaker or transfer switch.

Although the preceding description has been described herein with reference to particular circuits and embodiments, it is not intended to be limited to the particulars disclosed herein; rather, it extends to all functionally equivalent structures, methods, and uses, such as are within the scope of the appended claims.

The embodiments and examples set forth herein are presented to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims. The invention is specifically intended to be as broad as the claims below and their equivalents.

### Definitions

As used herein, the terms “a,” “an,” “the,” and “said” means one or more, unless the context dictates otherwise.

As used herein, the term “about” means the stated value plus or minus a margin of error, or plus or minus 10% if no method of measurement is indicated.

As used herein, the term “or” means “and/or” unless explicitly indicated to refer to alternatives only or if the alternatives are mutually exclusive.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise,” provided above.

As used herein, the terms “having,” “has,” and “have” have the same open-ended meaning as “comprising,” “comprises,” and “comprise,” provided above.

As used herein, the terms “including,” “includes,” and “include” have the same open-ended meaning as “comprising,” “comprises,” and “comprise,” provided above.

As used herein, the phrase “consisting of” is a closed transition term used to transition from a subject recited before the term to one or more material elements recited after the term, where the material element or elements listed after the transition term are the only material elements that make up the subject.

As used herein, the term “simultaneously” means occurring at the same time or about the same time, including concurrently.

### INCORPORATION BY REFERENCE

All patents and patent applications, articles, reports, and other documents cited herein are fully incorporated by reference to the extent they are not inconsistent with this invention.

What is claimed is:

1. A racking device for remote operation of a circuit breaker or transfer switch, the racking device comprising:
a motor and gear box operatively attached to a racking adapter configured to be engaged by and secured to a racking mechanism of the circuit breaker or transfer switch; and
an adjustable anti-rotation device affixed to the motor and gear box of the racking device, the adjustable anti-rotation device configured to:
engage a racking mechanism access window and/or a circuit breaker or transfer switch panel, wherein at least one plane of the anti-rotation device is substantially parallel with at least one plane of the racking mechanism access window and/or the circuit breaker or transfer switch panel; and
move the anti-rotation device substantially along an x-axis and/or a y-axis of the racking screw access window and/or a circuit breaker or transfer switch panel to compensate for a misalignment or dimensional variances between the racking adapter of the racking device and the racking mechanism of the circuit breaker or transfer switch.

2. The racking device of claim 1, wherein the anti-rotation device has one or more “L” bends.

3. The racking device of claim 1, wherein the adjustable anti-rotation device comprises a bracket, wherein the bracket is configured to engage one or more of a front surface feature of the circuit breaker or transfer switch panel, a gap in the circuit breaker or transfer switch panel or a side edge of the circuit breaker or transfer switch panel.

4. The racking device of claim 2, wherein the bracket comprises one or more “L” bends configured to engage the one or more of a front surface feature of the circuit breaker or transfer switch panel, a gap in the circuit breaker ore transfer switch panel or a side edge of the circuit breaker or transfer switch panel.

5. The racking device of claim 2, wherein the bracket has an “L” bend in the bracket to engage a gap in the circuit breaker or transfer switch panel.

6. The racking device of claim 1, wherein the adjustable anti-rotation device comprises:
a bracket;
a first linear bearings moveably attached to the bracket and the racking device and configured to allow an up-down adjustment substantially along the y-axis;
a second linear bearings moveably attached to the bracket and the racking device and configured to allow a side to side adjustment substantially along the x-axis.

7. The racking device of claim 1, wherein the racking adapter is further configured to:
adjust the racking adapter substantially along a z-axis of the racking mechanism to compensate for a misalignment or dimensional variances between the racking adapter of the racking device and the racking mechanism of the circuit breaker or transfer switch.

8. The racking device of claim 7, wherein the racking adapter comprises:
a plurality of holes configured to adjust the racking adapter substantially along a z-axis and to receive a pin, wherein the pin engages one of the plurality of holes in the racking adapter and a hole in the racking mechanism when the racking adapter is in an engaged position.

9. The racking device of claim 7, wherein the racking adapter comprises:
a first hole configured to receive a pin at a first end of the racking adapter, wherein the pin engages the first hole in the racking adapter and a hole in the racking mechanism when the racking adapter is in an engaged position; and/or
a sliding cam lock or an expanding two-piece socket at a second end of the racking adapter configured to adjust the racking adapter substantially along the z-axis.

10. The racking device of claim 1, wherein the racking adapter comprises a socket.

11. The racking device of claim 1, wherein the racking adapter comprises a shaft.

12. The racking device of claim 11, wherein the racking adapter has a hexagonal shape.

13. The racking device of claim 11, wherein the racking adapter has a round or circular shape with the cross-sectional hole.

14. The racking device of claim 11, wherein the racking adapter has a square shape.

15. The racking device of claim 1, wherein the racking adapter is adapted to be secured to the racking mechanism of the circuit breaker or transfer switch by an engagement means.

16. The racking device of claim 15, wherein the engagement means is one or more of a bracket, a friction fit, a latch, a magnet, and a pin.

17. The racking device of claim 16, wherein the engagement means is a pin.

18. A portable racking system for remote operation of a circuit breaker or transfer switch, the portable racking system comprising:
a racking device, the racking device comprising:
a motor and gear box operatively attached to a racking adapter configured to engage a racking mechanism; and
an anti-rotation device affixed to the motor and gear box of the racking device; and
a control device, the control device comprising a display and a user interface;
a carrying case electrically connected to and communicatively coupled to the racking device and the control device, the carrying case comprising:
a power supply; and
a computer processing device configured to receive, process and relay signals from the racking device to the control device.

19. The system of claim 18, wherein the racking device further comprises:
an adjustable position camera device movably attached to the motor and gear box, wherein the camera device is configured to align a camera aperture to view a circuit breaker or transfer switch panel when the racking adapter of the racking device engages the racking mechanism of the circuit breaker or transfer switch.

20. The system of claim 18, wherein the camera device is adapted to be secured to the motor and gear box of the racking device by an engagement means.

21. The system of claim 20, wherein the engagement means is one or more of a friction fit, a knob, and a pin.

22. The system of claim 21, wherein the engagement means is a knob.

23. The system of claim 19, wherein the camera device is configured to communicate a video feed to the computer processing device, and the computer processing device is configured to process and relay the video feed to the display of the control device.

24. The system of claim 1, wherein the racking device further comprises:
a shaft encoder, the shaft encoder coupled to the motor and gear box of the racking device and configured to determine a distance of and a direction of circuit breaker movement as a function of a number of revolutions of a racking mechanism.

25. A method to rack-out a circuit breaker or transfer switch, the method comprising:
(a) (a-1) inserting an anti-rotation device of a racking device into one or more of a front surface feature, gap or a side edge of a circuit breaker or transfer switch and (a-2) moving the racking adapter of the racking device relative to the racking mechanism of the circuit breaker or transfer switch substantially along an x-axis and/or a y-axis to compensate for misalignment or dimensional variances between the racking adapter of the racking device and the racking mechanism of the circuit breaker or transfer switch;
(b) operating the racking adapter of the racking device counterclockwise (or clockwise depending on the circuit breaker or transfer switch) to rack-out the circuit breaker or transfer switch; and
(c) stopping operation of the racking adapter of the racking device when the circuit breaker or transfer switch reaches a test position or a remove position.

26. The method of claim 25, wherein step (a-2) further comprises: moving the racking adapter of the racking device relative to the racking mechanism of the circuit breaker or transfer switch substantially along a z-axis to compensate for misalignment or dimensional variances between the racking adapter of the racking device and the racking mechanism of the circuit breaker or transfer switch.

27. The method of claim 25, wherein step (a) further comprises:
(a-3) securing the racking adapter of the racking device into the racking mechanism of the circuit breaker or transfer switch.

28. The method of claim 25, wherein step (c) further comprises: using an adjustable position camera device to determine when the circuit breaker or transfer switch reaches the test position or the remove position.

29. The method of claim 25, wherein step (c) further comprises: using a revolution counter to determine when the circuit breaker or transfer switch reaches the test position or the remove position.

30. A method to rack-in a circuit breaker, the method comprising:
(a) (a-1) inserting an anti-rotation device of a racking device into a racking mechanism of a circuit breaker or transfer switch and (a-2) moving the racking adapter of the portable racking device relative to the racking mechanism of the circuit breaker substantially along an x-axis and/or a y-axis to compensate for misalignment or dimensional variances between the racking adapter of the racking device and the racking mechanism of the circuit breaker or transfer switch;
(b) operating the racking adapter of the racking device clockwise (or counterclockwise depending on the circuit breaker or transfer switch) to rack-in the circuit breaker or transfer switch; and
(c) stopping the operation of the racking adapter of the racking device when the circuit breaker or transfer switch reaches a connected position.

31. The method of claim 30, wherein step (a-2) further comprises: moving the racking adapter of the racking device relative to the racking mechanism of the circuit breaker or transfer switch substantially along a z-axis to compensate for misalignment or dimensional variances between the racking adapter of the racking device and the racking mechanism of the circuit breaker or transfer switch.

32. The method of claim 30, wherein step (a) further comprises:
(a-3) securing the racking adapter of the portable racking device into the racking mechanism of the circuit breaker or transfer switch.

33. The method of claim 30, wherein step (c) further comprises using a camera device to determine when the circuit breaker or transfer switch reaches the connected position.

34. The method of claim 30, further comprising (d) removing the racking adapter of the racking device from the racking mechanism of the circuit breaker or transfer switch.

35. The method of claim 33, wherein step (c) further comprises using a revolution counter to determine when the circuit breaker or transfer switch reaches the connected position.

36. The method of claim 34, further comprising (d) removing the racking adapter of the racking device from the racking mechanism of the circuit breaker or transfer switch.

37. The racking device of claim 11, wherein the racking adapter has a splined polygonal shape.

38. The racking device of claim 11, wherein the racking adapter has a splined round or circular shape.

39. The racking device of claim 11, wherein the racking adapter has a splined square shape.

40. The method of claim 25, wherein step (c) further comprises: using an electronic current limiter to determine when the circuit breaker or transfer switch reaches the test position or the remove position.

41. The method of claim 30, wherein step (c) further comprises using an electronic current limiter to determine when the circuit breaker or transfer switch reaches the connected position.

42. The method of claim 30, further comprising (d) removing the racking adapter of the racking device from the racking mechanism of the circuit breaker or transfer switch.
